(19) United States
(12) Patent Application Publication
(10) Pub. No.: US 2007/0061289 A1
(43) Pub. Date: Mar. 15, 2007

(54) VALIDATOR AND METHOD FOR MANAGING DATABASE SYSTEM PERFORMANCE

(76) Inventors: Douglas Brown, Rancho Santa Fe, CA (US); Anita Richards, San Juan Capistrano, CA (US)

Correspondence Address: JAMES M. STOVER;NCR CORPORATION, 1700 SOUTH PATTERSON BLVD, WHQ4, DAYTON, OH, 45479, US

(21) Appl. No.: 11/468,070

(22) Filed: Aug. 29, 2006

Related U.S. Application Data
(60) Provisional application No. 60/715,815, filed on Sep. 9, 2005.
(60) Provisional application No. 60/715,814, filed on Sep. 9, 2005.

(51) Int. Cl. G06F 17/30

(52) U.S. Cl. 707/2

(57) ABSTRACT

A system for calculating demand on system resources in a database system, the system including an interface for receiving data indicative of database system operational characteristics; a processor responsive to the data for emulating the performance of a hypothetical database system having operational characteristics consistent with the data; and an analyzer responsive to the processor for providing a report indicative of the performance of the hypothetical database system.

### CROSS REFERENCE TO OTHER APPLICATIONS

This application claims priority under 35 U.S.C. §119(e) to the following co-pending and commonly-assigned patent application, which is incorporated herein by reference: Provisional Application Ser. No. 60/715,815, entitled “A SYSTEM AND METHOD FOR MANAGING A PLURALITY OF DATABASE SYSTEMS,” filed on Sep. 9, 2005, attorney's docket number 12162.

This application incorporates by way of cross reference the subject matter disclosed in: U.S. patent application Ser. No. 10/730,348, filed Dec. 8, 2003, entitled Administering the Workload of a Database System Using Feedback, by Douglas P. Brown, Anita Richards, Bhashyam Ramesh, Caroline M. Ballinger and Richard D. Glick, NCR Docket No. 11167; U.S. patent application Ser. No. 10/786,448, filed Feb. 25, 2004, entitled Guiding the Development of Workload Group Definition Classifications, by Douglas P. Brown, Bhashyam Ramesh and Anita Richards, NCR Docket No. 11569; and U.S. patent application Ser. No. 10/889,796, filed Jul. 13, 2004, entitled Administering Workload Groups, by Douglas P. Brown, Anita Richards, and Bhashyam Ramesh, NCR Docket No. 11560, and U.S. patent application Ser. No. 10/915,609, filed Aug. 10, 2004, entitled Regulating the Workload of a Database System, by Douglas P. Brown, Anita Richards, and Bhashyam Ramesh, NCR Docket No. 11561.

### BACKGROUND

Any discussion of the prior art throughout the specification should in no way be considered as an admission that such prior art is widely known or forms part of common general knowledge in the field.

As database management systems (DBMS) continue to increase in function and expand into new application areas, the diversity of database workloads is increasing as well. In addition to the classic relational DBMS workload consisting of short transactions running concurrently with long decision support queries, workloads comprising of an even wider range of system demands are emerging. New complex data types, such as image files, audio files, video files and other large objects, and new active data warehouse requirements, such as capacity on demand, data replication, fault-tolerance, dual active query processing, recursion, user defined types (UDFs), external UDFs, and so on, result in widely varying memory, processor, disk and network demands on database systems.

In general, a DBMS has a number of operational characteristics. These include physical statistics, such as CPU usage, query response times and performance statistics. In some DBMS, the operational characteristics include rule sets under which the database operates, relating to the likes of resource consumption and request prioritization. Varying these rule sets often has an effect on other physical characteristics, for example altering performance statistics. Ideally, a DBMS should be able to accept performance goals for a workload and dynamically adjust its own performance based on whether or not these goals are being met. Closed-loop system management (CLSM) is a technology directed towards this ideal. Under some known CLSM-type systems, incoming queries are split into workload groups, each workload group having respective performance goals. The DBMS is responsive to these whether or not these goals are met for selectively switching between predetermined rule sets or adjusting performance controls.

When working with new or existing workloads or applications, often the biggest hurdle in planning to accommodate the workloads is calculating the demand on system resources. In addition, suitable operational characteristics are required to manage the consumption of system resources. Known methods for achieving estimating demand are time consuming, costly and unreliable.

### SUMMARY

It is an object of the present invention to overcome or ameliorate at least one of the disadvantages of the prior art, or to provide a useful alternative.

In accordance with a first aspect of the invention, there is provided a validator for managing database system performance in a database system, the validator including:
an interface for receiving data indicative of database system operational characteristics;
a processor responsive to the data for emulating the performance of a hypothetical database system having operational characteristics consistent with the data; and
an analyzer responsive to the processor for providing a report indicative of the performance of the hypothetical database system.

A method for managing database system performance in a database system, the method including the steps of:
receiving data indicative of database system operational characteristics;
being responsive to the data for emulating the performance of a hypothetical database system having operational characteristics consistent with the data; and
being responsive to the emulation for providing a report indicative of the performance of the hypothetical database system.

### BRIEF DESCRIPTION OF THE DRAWINGS

The benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a system according to the invention; and

FIG. 2 is a flowchart showing an exemplary method of validation.

### DETAILED DESCRIPTION

Referring to the drawings, it will be appreciated that, in the different figures, corresponding features have been denoted by corresponding reference numerals.

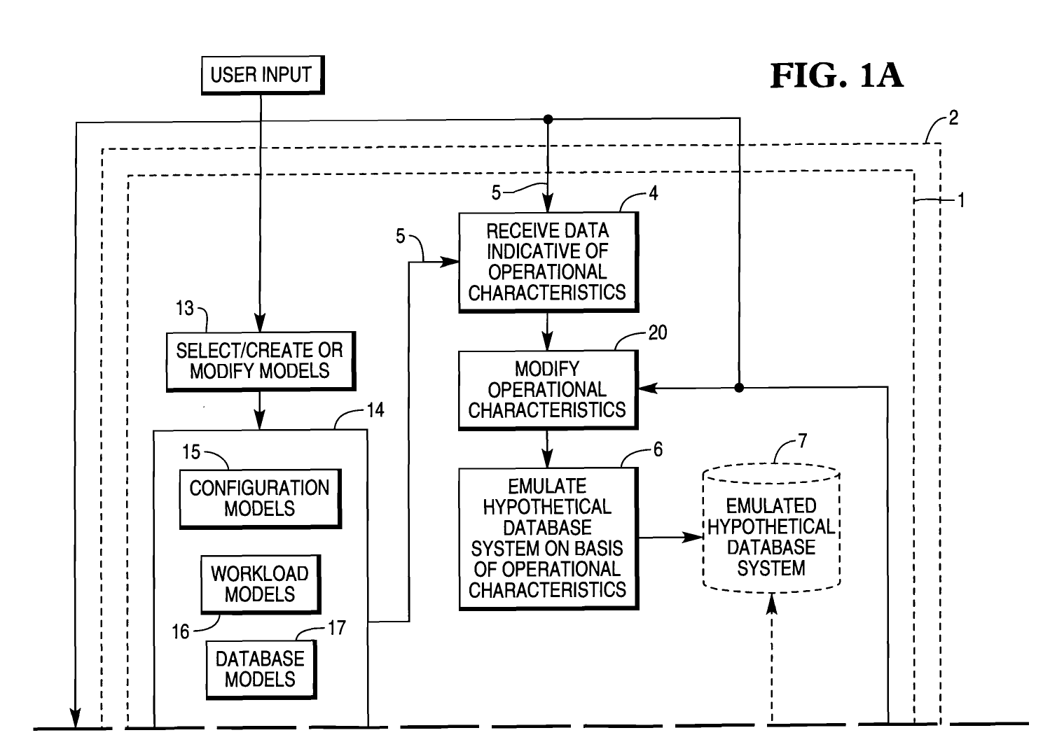

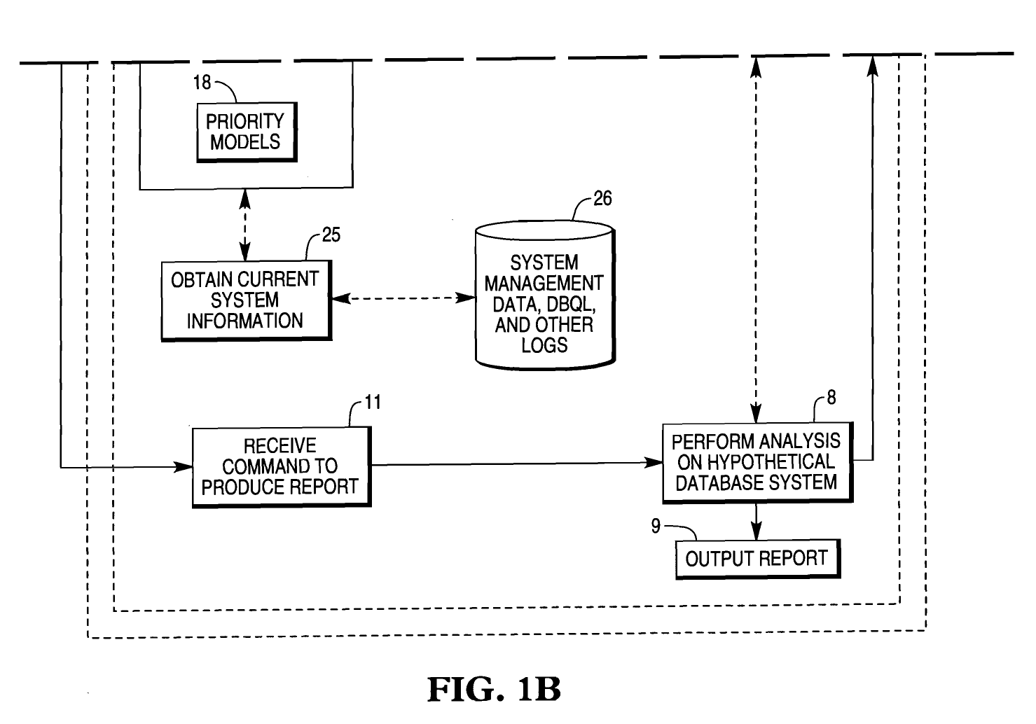

Referring initially to FIG. 1, there is provided a validator 1 for managing database system performance in a database system 2. System 1 includes an interface 4 for receiving data 5 indicative of database system operational characteristics. A processor 6 is responsive to data 5 for emulating the performance of a hypothetical database system 7 having operational characteristics consistent with data 5. An analyzer 8 is responsive to processor 6 for providing a report 9 indicative of the performance of the hypothetical database system.

System 2 is a CLSM type database, such as Teradata V2R6. Teradata is a trademark of NCR Corporation. In other embodiments alternate database systems are used. System 2 receives requests, which are separated and processed on the basis of workload definitions. Each workload definition has a respective predetermined processing expectation—a service level goal (SLG).

The term ‘performance’ is used to describe the efficiency with which a database system handles requests. This includes, but is not limited to, the likelihood of a SLG being met for a given workload definition, the response times for various workloads, and anticipated throughput rates. As such, performance is a somewhat subjective term, but typically relates to the rate at which requests are processed by database system 2.

Insofar as estimates are concerned within the present disclosure, while accuracy in estimates is important, absolute accuracy is unnecessary. To estimate within plus or minus 10% accuracy is generally acceptable.

It is appreciated that in some database systems there is only a single workload definition, and as such a single SLG. Although throughout the present disclosure it is assumed that there is a plurality of workload definitions, the teachings are equally applicable in cases where there is only a singular one.

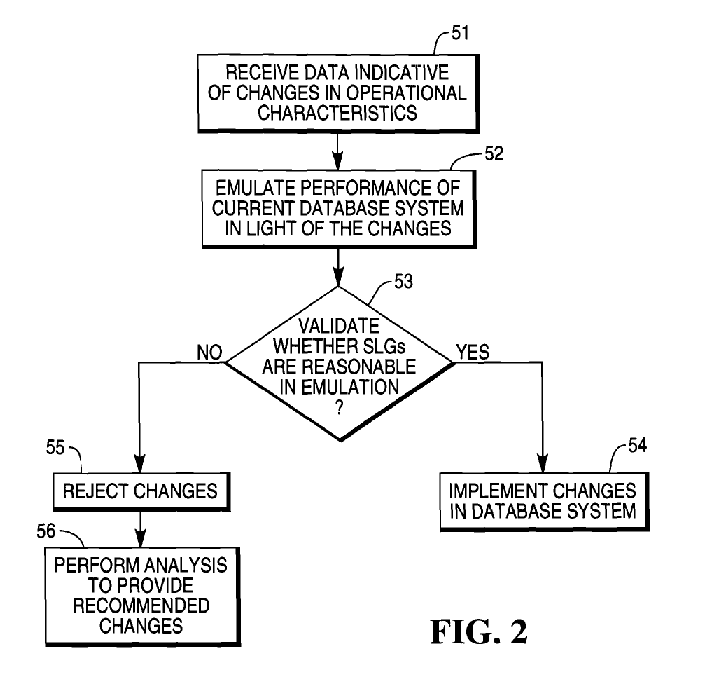

In some cases, system 2 and system 7 are identical. That is, processor 6 emulates the hypothetical performance of system 2. Despite this, it is typically of greater value to emulate a system 7 having incrementally different operational characteristics as compared to system 2. For example, different workload mixes, different arrival rates, alternate hardware configurations, and so on. In the present embodiment, validator 1 is used in conjunction with CLSM-type architecture, as best shown in FIG. 2. More specifically, validator 1 is used to assist in capacity and service level planning for system 2.

FIG. 1 schematically represents validator 1 as residing within database system 2. This is meant to illustrate that the functionality of validator 1 is internal to database system 2, as opposed to being built into an external component. In particular, processor 6 is integrated into the database engine of system 2. More specifically, components pre-existing in system 2 are used to as the basis of the functionality required to perform an emulation. In the present embodiment, system 2 is a Teradata V2R6database. The V2R6 engine makes use of a query optimizer, which is able to emulate system performance for the purpose of performing a cost-based analysis of workload performance. Processor 6 leverages functionalities of the query optimizer to provide the emulation of system 7. To assist in this, the query optimizer is extended to include a validator cost model for usage by processor 6 in the emulation.

Typically report 9 is indicative of the ability of system 7 to meet the SLGs of system 2. Despite this, the particulars of report 9 are varied between applications. For example, in some embodiments report 9 suggests one or more SLGs for usage with system 2 under given conditions. In the present embodiment analyzer is responsive to a user command for determining the particulars of report 9. That is, a user command 11 is received by analyzer 8, this command being indicative of a particular set of particulars that are to be included in report 9. Analyzer 8 analyzes the emulated performance of system 7 to obtain these particulars. In the present embodiment user command 11 is provided by any one of an internal database utility, an external data extraction tool, and a third party application. Report 9 is exported either as a table of data for either or both of inherent viewing or presentation by an external application.

Analyzer 8 facilitates two primary forms of analysis, referred to as ‘what if’ analysis and ‘reverse what if’ analysis. In the case of ‘what if’ analysis, report 9 contains particulars indicative of the performance of system 7 derived on the basis of a defined set of operating characteristics. In the case of ‘reverse what if’ analysis, report 9 is indicative of one or more sets of operating characteristics derived on the basis of defined system performance criteria. These are dealt with in greater detail below.

In some embodiments report 9 is a validation signal provided to system 2. This is illustrated in FIG. 2. A user proposes a new set of operational characteristics for system 2 at 51, such as a new set of workload definitions. Processor 6 emulates a hypothetical system 7 at 52, system 7 being system 1 with those new workload definitions in place. Analyzer 8 validates these characteristics at 53 to determine whether they are appropriate insofar as they allow defined SLGs to be met. A validation signal is provided, this signal being indicative of whether the proposed set of operational characteristics is appropriate. On the basis of this signal, system 2 either adopts at 54 or rejects at 55 the proposed set of changed operational characteristics. In some cases, recommendations are provided at 56, these being indicative of further changes that supplement the proposed changes to provide a workable system. This is carried out using ‘reverse what if’ analysis. For example, a new set of Priority Scheduler (PSF) settings are recommended to combine with the new workload definitions. It will be appreciated that such an approach is proactive rather than reactive. That is, rather then experiencing poor performance in system 2, the changes are validated to ensure poor performance is avoided. Further, recommendations are provided—where possible—to complement the proposed changes such that performance is not substantially adversely affected.

In a definitional sense, data 5 includes sufficient operational characteristics to allow emulation of system 7. The types of operational characteristics that make up data 5 vary between applications. Generally, the more operational characteristics that are provided, the more detailed the emulation. Further, ‘what if’ and ‘reverse what if’ analysis is only possible on operational characteristics that are included in data 5. For example, ‘what if’ analysis for changes in spool is only performable is the emulation of system 7 took account of spool in the first instance. Generally speaking, the primary operational characteristics required for emulation of system 7 are details of CPU, disk, network usage, database table and index statistics, Data Definition Language (DDL), Data Manipulation Language (DML), Schema, and so on. Modeling of a database system on the basis of characteristics such as CPU, disk and network usage is often performed using performance constant ratings. Preferably, validator 1 analyses these performance constant ratings in light of actual performance ratings derived from logs of system 2. Based on this analysis, one or more scaling factors are derived, which are used to improve the accuracy of emulations. These scaling factors are typically referred to as performance factors, power ratings and/or performance throughput ratings

In the present embodiment, data 5 is provided primarily in the form of models. A model is a collection of specific operational characteristics, and is selectively storable as models in an information repository 14, from where it is readily accessible for usage. An interface 13 is provided to facilitate the selection, modification and creation of these models. To create the models, inputs indicative of particular operational characteristics are provided to interface 13. These are then structured in accordance with predetermined modeling algorithms to create models for usage by processor 6. In the present case, there are four classes of models, each class of model including operational characteristics related to a particular aspect of a database system. Data 5 typically includes one model of each class. The models classes are:
Database models 15, which include data 5 indicative of schema, DDL, and table definitions.
Workload models 16, which include data 5 indicative of SQL and transaction definitions.
Configuration models 17, which include data 5 indicative of node, disk, AMP and PE definitions.
Priority models 18, which include data 5 indicative of a prioritizing protocol. In the present embodiment, system 2 makes use of Teradata Priority Scheduler Facility (PSF)—as such the prioritizing protocol is in the form of PSF settings.

In addition we also have a Simulation Model

In other embodiments alternate models are used.

A plurality of each of models 15 to 18 is storable in repository 14. A user selects one or models 15 to 18 from those available to be included in data 5. In the present embodiment only one of each of models 15 to 18 is used by processor 6 for emulation. For example, emulation is not carried out using two distinct configuration models 17 concurrently. It will be appreciated the rationale is that in practice a database system does not operate simultaneously under conditions defined by two distinct hardware setups.

In typical cases, interface 4 received data 5 in the form of one or more of models 15 to 18 that are nominated by a user. In cases where data 5 is supplied independently from a model, interface 4 organizes that data 5 into an appropriate one or more of the selected models.

Validator 1 includes an input 20 for modifying received data 5, including selected models 15 to 18. Modified models are selectively saved in repository 14 for future use. Input 20 is responsive to three main sources: direct user input to modify a particular characteristic; communication from interface 4 indicative of replacement operational characteristics; and commands from analyzer 8 indicative of instructions to make various modifications. Input 20 is in constant communication with processor 6 such that system 7 reflects the modified characteristics. In some embodiments this communication is periodic, or requires a specific “accept change” signal to be provided.

A probe 25 is provided to assist in defining models 15 to 18. Probe 25 obtains actual operational characteristics for system 2 from logs 26, and defines models on that basis. These are modifiable by using input 20. For example, models 15 to 18 are defined on the basis of up to date operational characteristics obtained by probe 25. A user performs a ‘what if’ analysis to examine system performance with half the number of nodes. In response to a signal from analyzer 20, input 20 modifies the configuration model 17 to halve the number of nodes. As such, system 7 substantially displays the performance statistics of system 2 where the number of nodes to be halved. Report 9 details the effect on performance resulting form halving the number of nodes.

In the present embodiment a probe 25 is a functionality of the Teradata System Emulation Tool (TSET). It will be appreciated that for processor 6 to emulate the performance of hypothetical system 7, a certain base level of data 5 is required. Probe 25 is used to supplement data 5 provided by a user to conveniently complete the required base level of data required by processor 6.

Consider an example where a new application is proposed for usage with database system 2. To emulate an appropriate system 7, an existing workload model 16 indicative of the current workload of system 2 is modified to include of a further set of SQL definitions on the basis of the new application. This existing workload model is created using probe 25, and is often updated using calculated scaling factors to account for the differences between hypothetical performance and known performance of system 2. In one case a user manually modifies model 17 to add further SQL definitions on the basis of the new application. In another case, the user instructs analyzer 8 to perform ‘what if’ analysis on the effect of adding the new application. In response, analyzer 8 uses input 20 to modify a model 17 to include appropriate SQL definitions. In either case, processor 6 performs an emulation to produce a report 9 indicative of the expected effect of the new application on the performance of database system 2. In some embodiments this report includes a comparison with the current known performance of database system 2, using calculated scaling factors, such as performance or power factors.

In the case of ‘reverse what if analysis’, input 20 follows one or more predefined algorithms to repeatedly modify one or more of models 15 to 18 to conduct comprehensive ‘what if’ analysis over a number of scenarios. Reports 9 from each of these examples of ‘what if’ analysis are themselves analyzed by analyzer 8 to provide recommendations in response to a user command. For example, a user requests a report from analyzer 8 that recommends PSF settings given a particular database model 15, workload model 16 and configuration model 17. Analyzer 8 repeatedly instructs input 20 to modify model 17 in accordance with a predefined algorithm. The outputted reports 9 are cross-compared, and recommendations made.

Validator 1 provides a modeling tool to assist system engineers, SQL designers, and database administrators in addressing performance issues regarding systems running CLSM architecture. It is implemented for performance prediction, capacity planning, system sizing, bottleneck analysis, index analysis, SQL design (including ad-hoc SQL), and SQL improvement.

When running performance models of a SQL workload, the critical factors that need to be accurate, in their order of importance, are:
(1) The SQL execution plans being modeled must accurately reflect the actual system plans.
(2) The logical I/O's being modeled must accurately reflect the actual system logical I/O's.
(3) The physical I/O's being modeled, as well as the disk cache hit rates applied to the logical I/O's to get physical I/O's, must accurately reflect actual system behavior.
(4) Finally, the hardware resources (I/O, CPU, BYNET Nodes, etc.) must be modeled accurately.

In the present embodiment, validator 1 satisfies the above requirements as follows:
Validator 1 leverages functionalities of Teradata Parser/Optimizer to provide estimates versus actuals, which suitably assures that execution plans being modeled reflect the actual system execution plans.
Validator 1 leverages the functionality of Teradata Optimizer to predict logical I/O data. In some cases, a user overrides this with manually supplied predicted data.
Validator 1 calculates predicted physical I/O's using algorithms for calculating cache hit rates.

As such, validator 1 provides the ability to predict system performance and the effects of new applications and new workloads on system performance. Further, ‘what if’ analysis is performed to estimate the effects of operational characteristics variations. In particular, processor 6 is adapted to calculate throughput and response times based on:

Varied workload definitions.

Varied priorities for existing for varied workload definitions.

Changes in arrival rates.

Data demography changes.

Physical database design changes.

The implementation of specific application packages.

Changes in throttle definitions.

Processor 6 is adapted to automatically internally adjust the operational characteristics of hypothetical system 7 to suggest operational characteristics to meet one or more particular SLGs. This ‘reverse what if’ analysis provides recommendations for operational characteristics rather than merely validate a given set of conditions. For example, a user specifies a desired response time for a workload A within a total mixed workload. Processor 6 validates the ability to meet that SLG given the existing specified operational characteristics, and recommends changes in, for example, any one or more of the following:

SLGs for one or more workload definitions.

PSF settings.

Enforcement priorities.

Workload definitions.

Throttle definitions.

Physical database design.

In the illustrated embodiment, validator 1 is operable on a number of differing levels of complexity, as outlined below. A user specifies the level of complexity dependant on the desired outcome. It will be appreciated that, at the complexity increases, so does the level of CPU required to perform the task. In the case of 4^{th} level analysis, it is not unusual for a processing run to continue for periods of days or longer.

1st Level—Generating a configuration model without analysis. At this level validator 1 builds a new Configuration Model to explicit specifications provided by a user. A user specifies a number of nodes, a number of CPU's per node, a number of PE's, a disk array model, and other such information required to define a database system configuration.

2nd Level—Generating a configuration model with performance analysis. At this level a workload model is used to size the system that's required. That is, a new Configuration Model is automatically designed based on user input. At this level the workload model uses performance factors or performance ratings produced from Teradata Choosing Calculator Technology.

3rd Level—Analytic Performance Analysis. At this level, validator 1 performs a cost-based analysis of the performance of system 7, including the ‘what if’ scenarios described above. This provides relatively fast response to the user in generating system configurations, analyzing indexes, and analyzing system performance. Quantitative performance prediction is, however, sacrificed for speed of execution. Analytic Performance Analysis provides reports that are used for qualitative performance comparisons to characterize a change between two distinct Analytic Performance Analysis runs. The resulting detailed performance reports include logical I/O and physical I/O counts (DBUCOUNT) for each table, spool file, and index utilized when executing each SQL statement in the identified workload. This functionality is similar to the “Create Workload” and “Batch Compare” functionality of Teradata's Index Wizard, Visual Explain and Teradata Manager's Trend analysis. For example, this functionality allows a user to create reports using Teradata's “Predicate Analysis” to analyze for potential Indexes, Statistics collection, Spool, Skew, etc.

4th Level—Simulated Performance Analysis. This level uses the most accurate of the general performance modeling techniques to provide quantitative performance predictions. Quantitative performance prediction is available through the emulation provided by processor 6. This option allows a user to simulate a workload by modeling “what-if” changes in workload and system conditions. The accuracy of this level over Analytic Performance Analysis involves additional CPU and elapsed time to complete the modeling analysis. The resulting detailed performance reports include the best-case, the average-case, and the worst-case response times for all of the transactions including recommendations for PSF settings. The reports also provide resource utilization percentages for disks, disk array controllers, CPU's, and BYNET.

Although the present invention has been described with particular reference to certain preferred embodiments thereof, variations and modifications of the present invention can be effected within the spirit and scope of the following claims.

What is claimed is:

1. A validator for managing database system performance in a database system, the validator including:
an interface for receiving data indicative of database system operational characteristics;
a processor responsive to the data for emulating the performance of a hypothetical database system having operational characteristics consistent with the data; and
an analyzer responsive to the processor for providing a report indicative of the performance of the hypothetical database system.

2. A validator according to claim 1 wherein the database system uses CLSM-type architecture.

3. A validator according to claim 1 wherein the processor is integrated into the engine of the database system.

4. A validator according to claim 3 wherein the database system includes a query optimizer, and the processor leverages one or more functionalities of the query optimizer.

5. A validator according to claim 4 wherein the query optimizer is extended to include a validator cost model for usage by the processor.

6. A validator according to claim 1 wherein the interface organizes the data into a plurality of models.

7. A validator according to claim 9 wherein the models include:
a database model including data indicative of schema, DDL, and table definitions;
a workload model including data indicative of SQL and transaction definitions;
a configuration model including data indicative of node, disk, AMP and PE definitions; and
a priority model including data indicative of a prioritizing protocol.

8. A validator according to claim 9 wherein the models are selectively storable in and accessible from an information repository.

9. A validator according to claim 1 wherein the interface includes an input for modifying the received data.

10. A validator according to claim 9 wherein the report is prepared on the basis of a user command and the input is responsive to the user command for modifying the received data.

11. A validator according to claim 1 including a probe for obtaining data indicative of operational characteristics of the database system and providing this data to the interface.

12. A validator according to claim 11 wherein the probe obtains data from one or more performance logs maintained by the database system.

13. A validator according to claim 11 wherein the probe obtains data on the basis of an analysis of the hardware configuration of the database system.

14. A validator according to claim 11 wherein the probe obtains data on the basis of an analysis of the physical design of the database system.

15. A validator according to claim 11 where data obtained by the probe is used to calculate performance factors to adjust theoretical performance calculations for conformity with actual performance.

16. A validator according to claim 1 wherein the report provides a comparison of the performance of the database system to the hypothetical database system.

17. A validator according to claim 1 wherein the report includes details of one or more relationships between operational characteristics and performance.

18. A validator according to claim 1 wherein the operational characteristics include CPU, disk and network particulars.

19. A validator according to claim 1 operable at a plurality of levels requiring respective threshold amounts of the data.

20. A validator according to claim 19 wherein the levels include any one or more of:
a first level for generating a configuration model without performance analysis;
a second level for generating a configuration model with performance analysis;
a third level for analytic performance analysis; and
a fourth level for simulated performance analysis.

21. A method for managing database system performance in a database system, the method including the steps of:
receiving data indicative of database system operational characteristics;
being responsive to the data for emulating the performance of a hypothetical database system having operational characteristics consistent with the data; and
being responsive to the emulation for providing a report indicative of the performance of the hypothetical database system.
